(19) United States
(12) Patent Application Publication
(10) Pub. No.: US 2017/0051809 A1
(43) Pub. Date: Feb. 23, 2017

(54) Vehicle Spoke Wheel Weight

(71) Applicant: Kibblewhite Precision Machining, Inc., Pacifica, CA (US)

(72) Inventors: William Francis Kibblewhite, Pacifica, CA (US); Jacob Winslow Harrington, Golden, CO (US)

(73) Assignee: Kibblewhite Precision Machining, Inc., Pacifica, CA (US)

(21) Appl. No.: 15/137,872

(22) Filed: Apr. 25, 2016

Related U.S. Application Data
(60) Provisional application No. 62/207,758, filed on Aug. 20, 2015.

(51) Int. Cl. F16F 15/32; F16F 15/34

(52) U.S. Cl. CPC F16F 15/326; F16F 15/345

(57) ABSTRACT

A vehicle spoke wheel weight includes a body, with first and second body parts, and a fastener assembly. Each body part includes a central bore having an upper bore surface, a lower bore surface and a shoulder connecting the upper and lower bore surfaces. The lateral dimension of the lower bore surface is larger than the lateral dimension of the shoulder. The first and second body parts are placeable in a mounting orientation with the central bores of each opposite one another and securable to one another by the fastener assembly. The upper and lower bore surfaces and the shoulder of each body part can define generally semi-cylindrical surfaces of less than a full semicircle. A shim material can be placeable at the upper bore surfaces. A method for making a vehicle spoke wheel weight includes forming a body and creating a fastener assembly.

### CROSS-REFERENCE TO OTHER APPLICATIONS

This application claims the benefit of U.S. provisional patent application No. 62/207,758 filed 20 Aug. 2015.

This application is related to U.S. design patent application 29/541,755, filed 7 Oct. 2015.

### FEDERALLY SPONSORED RESEARCH OR DEVELOPMENT

None.

### BACKGROUND OF THE INVENTION

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

For optimal operation, a wheel is required to be round and balanced. An unbalanced condition occurs when the center of gravity of the wheel is not located precisely upon its axis of rotation. Small variations in symmetry and mass can cause wheels to be unbalanced. In this condition, the normal operational motion of spinning can create negative and even unsafe vibrations that can be perceived by the operator and affect performance. These vibrations can increase in severity as the speed of the wheel increases.

The act of wheel balancing uses specialized equipment to determine the location of an imbalance and subsequently the corresponding location where mass can be added to the wheel to create a state of balance. Small masses, often referred to as wheel weights, are commonly attached to a wheel using an adhesive, by crimping (physical deformation through the use of force), or by the fastening to a wheel with a threaded tightening mechanism (such as a screw) upon the spoke nipple.

Historically, wheel weights have either been made of lead (Pb), as the malleability of lead lends to deformation by crimping, or made of materials containing some percentage of lead. However many recent state and local regulations have severely limited the amount of lead acceptable for use in wheel weights, making many current crimpable, lead-containing products illegal.

### BRIEF SUMMARY OF THE INVENTION

An example of a vehicle spoke wheel weight includes a body and a fastener assembly. The body has first and second body parts. Each body part includes a central bore having an upper bore surface, a lower bore surface and a shoulder connecting the upper and lower bore surfaces. The upper and lower bore surfaces and the shoulder have lateral dimensions, the lateral dimension of the lower bore surface being larger than the lateral dimension of the shoulder. The first and second body parts are placeable in a mounting orientation with the central bores of each opposite one another. The first and second body parts are securable to one another by the fastener assembly when in the mounting orientation.

Examples of the vehicle spoke wheel weight can include one or more the following. The upper and lower bore surfaces and the shoulder of each body part can define generally semi-cylindrical surfaces of less than a full semicircle. A shim material can be placeable at the upper bore surfaces. The fastener assembly can include a threaded fastener assembly. When the first and second body parts are in the mounting orientation, the first and second body parts can define a longitudinally extending gap therebetween, and the fastener assembly can include a fastener element extendable between the first and second body parts and through the longitudinally extending gap. When the first and second body parts are in the mounting orientation, the first and second body parts can define first and second longitudinally extending gaps therebetween, and the fastener assembly can include a fastener element extendable between the first and second body parts and through each of the longitudinally extending gaps. The lateral dimensions of the shoulder and the upper bore surface can be the same.

An example of a spoked wheel assembly includes a circular wheel rim, a spoke/nipple assembly, and a vehicle spoke wheel weight. The spoke/nipple assembly includes a spoke nipple mounted to the wheel rim. The spoke nipple has an outer end from which a spoke extends radially inwardly, the outer end having a lateral dimension. The vehicle spoke wheel weight includes a body having first and second body parts, and a fastener assembly. Each body part has a central bore has an upper bore surface, a lower bore surface and a shoulder connecting the upper and lower bore surfaces. The upper and lower bore surfaces and the shoulder have lateral dimensions with the lateral dimension of the lower bore surface being larger than the lateral dimension of the shoulder. The lateral dimension of the shoulder is smaller than the lateral dimension of the outer end of the nipple. The first and second body parts are placeable in a mounting orientation with the central bores of each located opposite one another with: the upper bore surfaces opposite the spoke; the lower bore surfaces opposite the nipple; the shoulders contacting the outer end of the spoke nipple; and the body being spaced apart from the wheel rim. The fastener assembly secures the first and second body parts to one another when in the mounting orientation thereby biasing the lower bore surface against the nipple to secure the vehicle spoke wheel weight to the spoke/nipple assembly.

A method for making a vehicle spoke wheel weight includes forming a body and creating a fastener assembly. The vehicle spoke wheel weight is of the type for use with a spoke/nipple assembly including a spoke nipple mounted to a circular wheel rim, the spoke nipple having an outer end from which a spoke extends radially inwardly. The body is formed with first and second body parts with each body part having a face surface. The body forming step includes creating a central bore in each body part extending from the face surface, the central bore having an upper bore surface, a lower bore surface and a shoulder connecting the upper and lower bore surfaces, the lower bore surface having a larger lateral dimension than the lateral dimension of the shoulder. The body forming step also includes forming the central bore so that the central bore of each body part defines a surface of less than a full semi-circle. The fastener assembly creating step includes creating a fastener assembly for securing the first and second body parts to one another when the first and second body parts are placed in a mounting orientation with the face surfaces and the central bores of each opposite one another. The body forming step further includes configuring the first and second body parts so that the lower bore surface can securely engage a range of sizes of spoke nipples when secured thereto by the fastener assembly.

Some examples of the vehicle spoke wheel weight making method can include one or more the following. The shoulder can be configured to be placeable against an outer end of a spoke nipple, the spoke nipple having a height. The height of the lower bore surface can be limited to be less than the height of the spoke nipple so that the body is spaced apart from the wheel rim. The first and second body parts can define a longitudinally extending gap between the face surfaces when in the mounting orientation; the first and second body parts configuring step can include sizing of the gap and sizing of the lateral dimensions of the lower bore surfaces so that the lower bore surfaces of the first and second body parts can be biased against the spoke nipple by the fastener assembly over said range of sizes of spoke nipples.

Other features, aspects and advantages of implementations of this disclosure can be seen on review the drawings, the detailed description, and the claims which follow.

### BRIEF DESCRIPTION OF THE DRAWINGS

FIG. 1 illustrates a section of a circular wheel rim with a radially-inwardly extending spoke/nipple assembly mounted to the wheel rim and an exploded view of an example of a wheel weight positioned for mounting to the spoke/nipple assembly.

FIG. 2 is a side, top view of the wheel rim and spoke/nipple assembly of FIG. 1 with one of the body parts contacting the spoke nipple.

FIG. 3 is an isometric view of the body of the wheel weight of FIG. 1 with the body parts positioned opposite one another.

FIG. 4 is a side view of the vertical face of one of the body parts of FIG. 3.

FIG. 4A is a side view of an alternative example of the body part of FIG. 4.

FIG. 5 is atop plan view of one of the body parts of FIG. 3.

FIG. 6 is a view of the structure of FIG. 1 with the wheel weight secured to the spoke/nipple assembly.

FIG. 7 is a cross-sectional view taken along line 7-7 of FIG. 6.

FIG. 8 is an exploded view similar to that of FIG. 3 but illustrating different shim materials for use between the outer end of the upper bore surface and the spoke.

FIG. 9 shows an example of a set of different size wheel weights ranging from 0.5 ounce through 1.5 ounces in 0.25 ounce increments.

### DETAILED DESCRIPTION

The following description will typically be with reference to specific structural embodiments and methods. It is to be understood that there is no intention to-be limited to the specifically disclosed embodiments and methods but that other features, elements, methods and embodiments may be used for implementations of this disclosure. Preferred embodiments are described to illustrate the technology disclosed, not to limit its scope, which is defined by the claims. Those of ordinary skill in the art will recognize a variety of equivalent variations on the description which follows. Unless otherwise stated, in this application specified relationships, such as parallel to, aligned with, or in the same plane as, mean that the specified relationships are within limitations of manufacturing processes and within manufacturing variations. When components are described as being coupled, connected, being in contact or contacting one another, they need not be physically directly touching one another unless specifically described as such. Like elements in various embodiments are commonly referred to with like reference numerals.

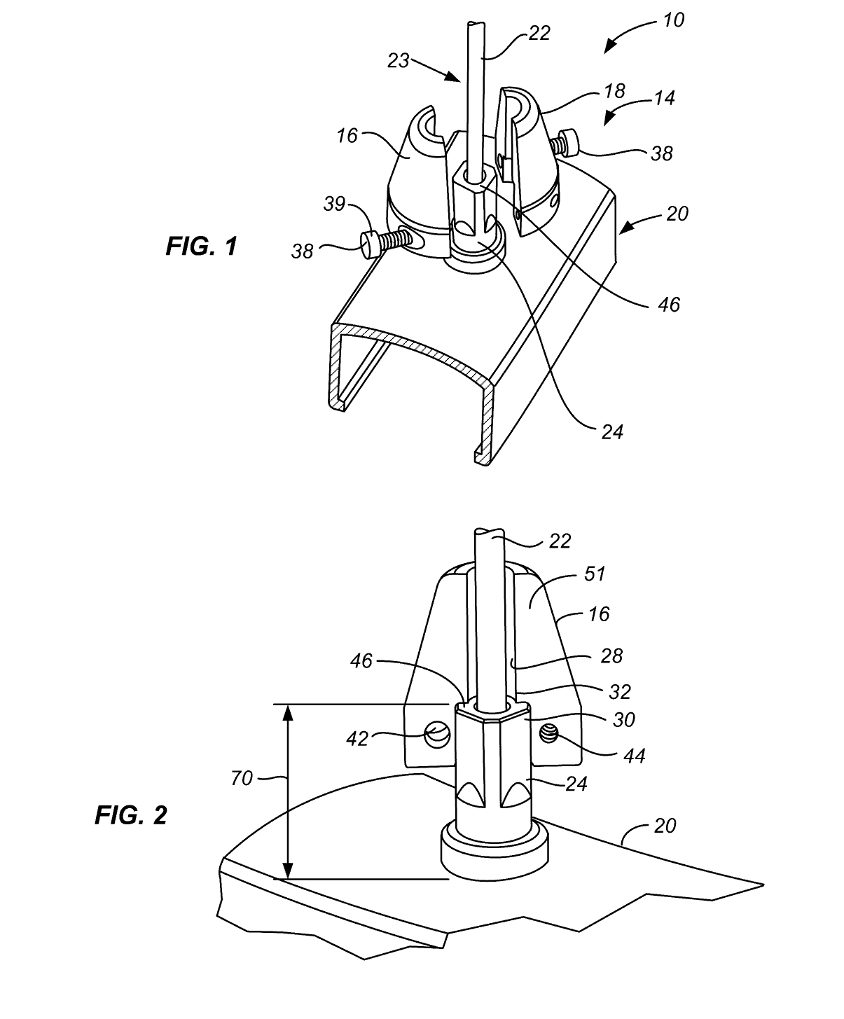

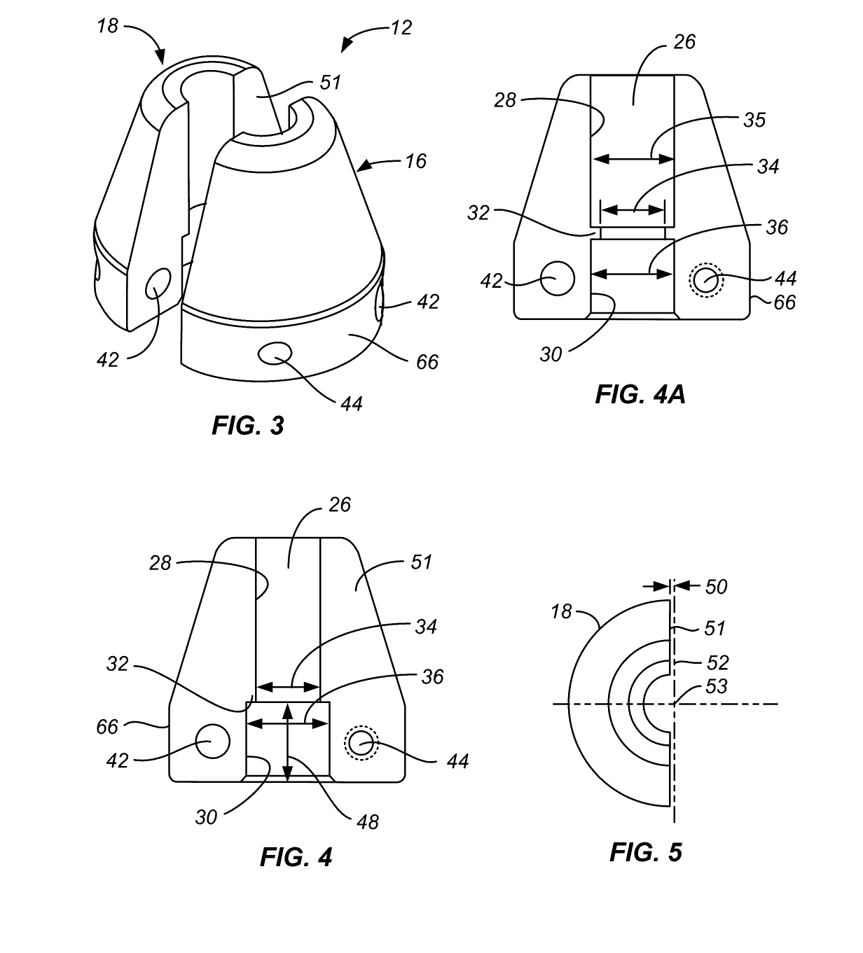

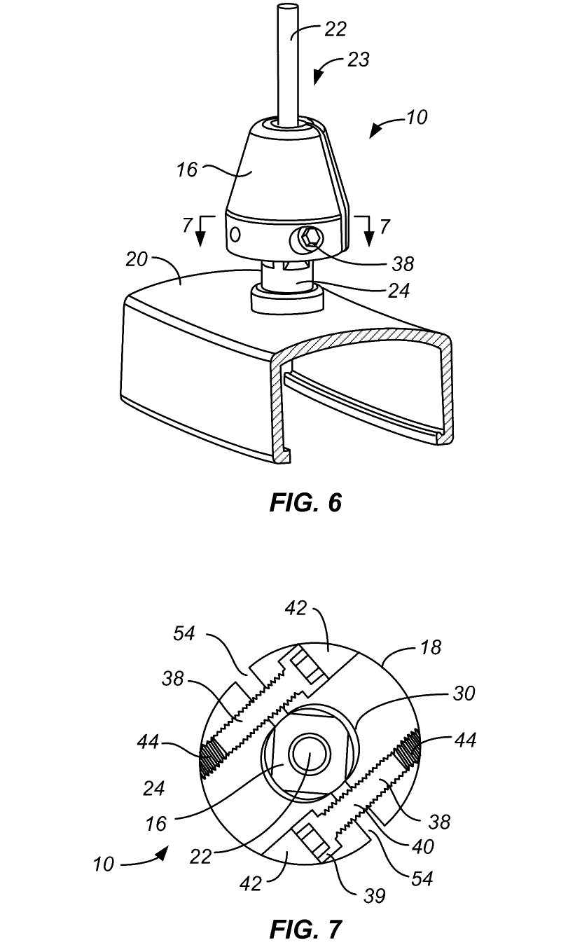

Referring now to FIGS. 1-6, an example of a vehicle spoke wheel weight 10 is shown to include a body 12 and a fastener assembly 14. FIGS. 1 and 6 also disclose a section of a circular wheel rim 20 from which the spoke 22 of a spoke/nipple assembly 23 extends radially inwardly. Spoke 22 is secured to wheel rim 20 by a spoke nipple 24.

Body 12 includes first and second body parts 16, 18 which, in this example, are identical to one another thereby lowering manufacturing an inventory costs. Each body part 16, 18 has a generally semi-cylindrical central bore 26 having an upper bore surface 28, a lower bore surface 30 and a shoulder 32 connecting the upper and lower bore surfaces. The upper bore surface 28 and shoulder 32 have the same lateral dimension, indicated by arrow 34. In this example the lateral dimension 34 of both upper bore surface 28 and shoulder 32 is less than the lateral dimension of lower bore surface 30, indicated by arrow 36.

In some examples, the upper bore surface 28 may have a lateral dimension equal to, greater than or less than the lateral dimension of shoulder 32. In the example of FIG. 4A, upper bore surface 28 has a lateral dimension 35 less than the lateral dimension 34 of shoulder 32 but equal to the lateral dimension 36 of lower bore surface 30. In the examples of FIG. 4 and FIG. 4A, shoulder 32 is continuous, generally semicircular element; in some examples shoulder 32 may be created by a number of shoulder segments separate by gaps.

Fastener assembly 14, in this example, includes a pair of cap screws 38, each having a head 39 and a threaded shank 40, as shown best in FIGS. 1 and 7. Each of the first and second body parts 16, 18 has a threadless, counterbored mounting hole portion 42 and a threaded mounting hole portion 44. The hole portions 42, 44 are positioned so that hole portions 42 of body parts 16, 18 are aligned with hole portions 44 of body parts 18, 16. Accordingly, cap screws 38 can be inserted into the threadless, counterbored mounting hole portions 44 of first and second body parts 16, 18 to threadably engage threaded mounting hole portions 44 of second and first body parts 18, 16 thus securing the body parts to one another while surrounding the base of spoke 22 and at least a portion of spoke nipple 24.

In the example of FIG. 4, the lateral dimensions of upper and lower bore surfaces 28, 30 and shoulder 32 are sized and shoulder 32 is positioned so that shoulder 32 rests on the outer end 46 of spoke nipple 24. The height 48 of lower bore surface 30 is chosen so that body 12 is spaced apart above wheel rim 20 to ensure the proper engagement of spoke nipple 24 and shoulder 32.

In some examples body parts 16, 18 are sized to so that the generally central bore 26 of each defines a generally semi-cylindrical curved surface of less than a full semicircle. This is indicated by offset 50 in FIG. 5; offset 50 is the distance between the vertical face 51 of each body part 16, 18 and a line 52 extending generally parallel to vertical face 51 and passing through the center 53 of central bore 26. Other ways of creating offset 50 can also be used. By properly choosing lateral dimension 36 and offset 50, the lower bore surface 30 of the central bore 26 will rest tightly against the spoke nipple 24 over a range of sizes of spoke nipples 24. For example, with a larger spoke nipple 24, the gap 54, see FIG. 7, between the two sides may be, for example, 0.045 inch while with a smaller nipple the gap may be very small or nonexistent. This feature allows the same wheel weight 10 to be used with a number of different types and sizes of spoke/nipple assemblies 23.

Wheel weight 10 has an aesthetic vintage over conventional wheel weights of the type having an axially-extending, lateral mounting slot sized to permit the conventional wheel weight to be mounted onto the spoke/nipple assembly; conventional wheel weights of this type typically have a set screw which is tightened onto the spoke nipple to keep the wheel weight in place. The lateral mounting slot of such conventional wheel weights must be at least the width of the nipple diameter for the wheel weight to slide over and be mounted to the spoke/nipple assembly. In contrast, wheel weight 10 can be comprised of two, typically symmetrical, body parts 16, 18 which are secured to one another together using, for example, cap screws 38, once positioned around spoke 22 and spoke nipple 24. This allows gaps 54 of wheel weight 10 to be dramatically smaller than would be possible with conventional wheel weights thus increasing the aesthetic appeal of the product.

Wheel weight 10 also provides a practical advantage over conventional wheel weights having an axially-extending, lateral mounting slot and one or more set screws. Body parts 16, 18 are placed on either side of the spoke 22 and spoke nipple 24 and in some examples are secured together with two cap screws 38. Cap screws 38, or other fastener structures, extend across each gap 54 thus preventing removal of wheel weight 10 from spoke/nipple assembly 23 through a gap 54 so long as the threaded shank 40 of the cap screw 38 extending across that gap 54 is threadably engaged with threaded mounting hole portion 44. Therefore, even if one of the cap screws 38 loosens somewhat, the lack of an unobstructed lateral mounting slot substantially eliminates the chance for wheel weight 10 to come off of the spoke/nipple assembly 23. In contrast, a loosened set screw of a conventional wheel weight of the type having an axially-extending, lateral mounting slot, allows the wheel weight to fall off and be lost.

In the disclosed example of FIGS. 1-8, the upper and lower bore surfaces 28, 30 are smoothly curving, generally semi-cylindrical surfaces. The upper bore surface 28 may be semi-cylindrical or not and may or may not be smoothly curving surfaces. The lower bore surface 30 may be other than a smoothly curving, semi-cylindrical surface to, for example, conform to a nipple having four flat surfaces.

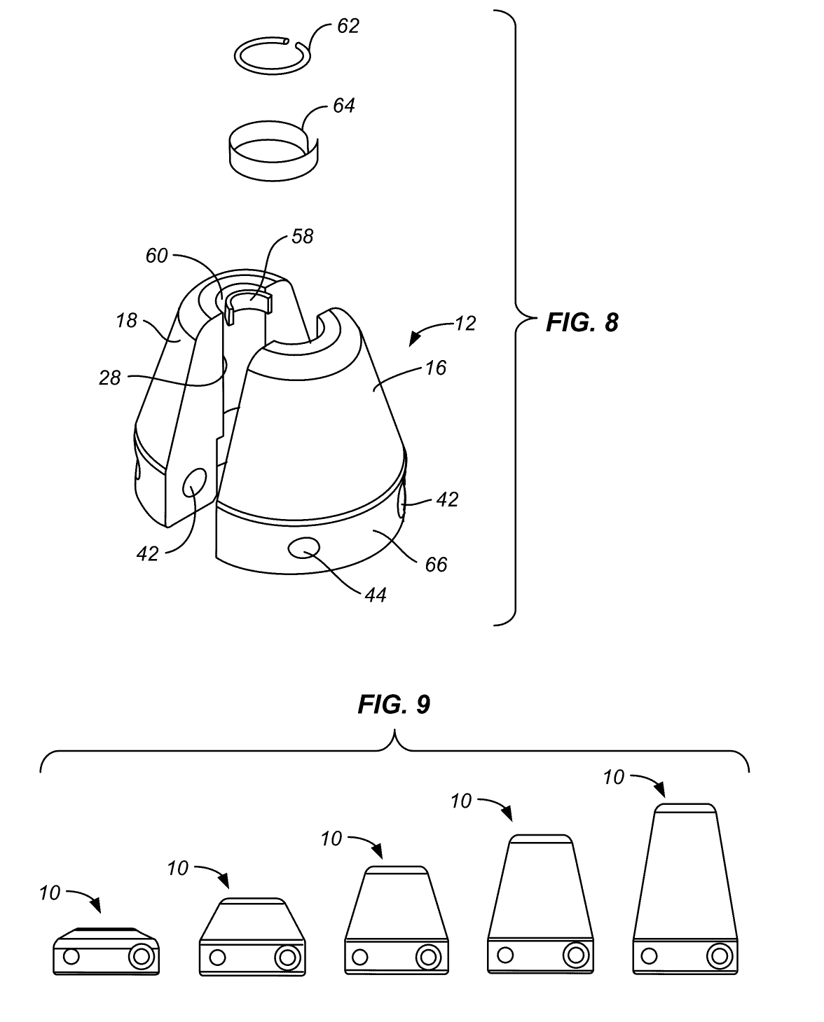

In some examples some type of shim material can be used between the outer end of the upper bore surface and the spoke. The purpose of the shim material can be to keep the wheel weight 10 from vibrating against the spoke 22. In one example, see FIG. 8, a layer of silicon or other similar material acting as a shim 58 is applied to the outer end 60 of the upper bore surface 28. Also, an O-ring groove, not shown, could be formed at the outer end 60 of the upper bore surface 28 to receive, for example, a rubber O-ring 62. O-ring 62 could be a split O-ring so that it could be placed around the spoke 22 by the user prior to being captured between the two wheel weight body parts 16, 18. Another way, not illustrated in the figures, to provide the shim would be to squirt a little silicon, or other suitable material, between the weight and the spoke after the weight has been mounted to the spoke. A further way would be to wrap a length of shim material 64 about the spoke 22 prior to mounting the wheel weight body part 16, 18 onto the spoke and nipple assembly 23.

The fastener assembly 14 of wheel weight 10 can be replaced by other types of fastener assemblies. For example, instead of using cap screws 38, a conventional cable tie can be passed through both pairs of hole portions 42, 44 and cinched down to quickly secure wheel weight 10 onto spoke nipple 24. Alternatively, although not presently preferred, a conventional hose clamp can be placed around the cylindrical outer surface 66 of body 12 and tightened to secure body 12 onto spoke nipple 24. Also, first and second body parts 16, 18 could be secured to one another along one side by a hinged structure to create a gap 54 along the opposite side; in this example only a single cap screw 38 would be needed.

In some of the examples discussed above, body parts 16, 18 are identical. While there are typically cost advantages to having the body part 16, 18 be identical, in some examples body parts 16, 18 can be other than identical. FIGS. 9A-9E show an example of a set of different sized wheel weights 10.

A method for making an example of a vehicle spoke wheel weight 10 of the type for use with a range of sizes of spoke nipples 24 can be carried out as follows. First and second body parts 16, 18 are formed. A central bore 26 is formed in each body part 16, 18. The central bore 26 has an upper bore surface 28, a lower bore surface 30 and a shoulder 32 connecting the upper and lower bore surfaces. The central bore 26 is formed so that the lower bore surface 30 has a larger lateral dimension 36 than the lateral dimension 34 of the shoulder 32. The central bore 26 can be formed so that each body part 16, 18 defines a surface of less than a full semi-circle. A fastener assembly 14 is created for securing the first and second body parts 16, 18 to one another with the central bores 26 of each opposite one another. The lower bore surface is sized so that the lower bore surface can securely engage the range of sizes of spoke nipples 24 when secured thereto by fastener assembly 14.

A method for making a vehicle spoke wheel weight 10 can include configuring the shoulder 32 to be placeable against outer end 46 of spoke nipple 24. The spoke nipple 24, see FIG. 2, has a height 70 as measured from wheel rim 20. The first and second body parts are configured so that when shoulder 32 is placed against outer end 46 of spoke nipple 24, the lower bore surfaces 30 of the first and second body parts 16, 18 can be biased against the spoke nipple 24 by the cap screws 38 of fastener assembly 14; this configuring can include sizing of gap 54 and sizing the lateral dimension 36 of lower bore surface 30. Lower bore surface 30 is also sized to limit the height 48 of the lower bore surface to be less than the height 70 of spoke nipple 24 so that body 12 is spaced apart from wheel rim 20.

The above descriptions may have used terms such as above, below, top, bottom, over, under, et cetera. These terms may be used in the description and claims to aid understanding what is being disclosed and not used in a limiting sense.

While implementations of the technology are disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the technology disclosed and the scope of the following claims.

One or more elements of one or more claims can be combined with elements of other claims.

Any and all patents, patent applications and printed publications referred to above are incorporated by reference.

What is claimed is:

1. A vehicle spoke wheel weight comprising:
a body comprising first and second body parts;
each body part comprising a central bore having an upper bore surface, a lower bore surface and a shoulder connecting the upper and lower bore surfaces;
the upper and lower bore surfaces and the shoulder having lateral dimensions, the lateral dimension of the lower bore surface being larger than the lateral dimension of the shoulder;
a fastener assembly; and
the first and second body parts being placeable in a mounting orientation with the central bores of each opposite one another, the first and second body parts being securable to one another by the fastener assembly when in the mounting orientation.

2. The wheel weight according to claim 1, wherein the upper and lower bore surfaces and the shoulder of each body part define generally semi-cylindrical surfaces of less than a full semicircle.

3. The wheel weight according to claim 1, further comprising a shim material placeable at the upper bore surfaces.

4. The wheel weight according to claim 1, wherein the fastener assembly comprises a threaded fastener assembly.

5. The wheel weight according to claim 1, wherein when the first and second body parts are in the mounting orientation:
the first and second body parts define a longitudinally extending gap therebetween; and
the fastener assembly comprises a fastener element extendable between the first and second body parts and through the longitudinally extending gap.

6. The wheel weight according to claim 1, wherein when the first and second body parts are in the mounting orientation:
the first and second body parts define first and second longitudinally extending gaps therebetween; and
the fastener assembly comprises a fastener element extendable between the first and second body parts and through each of the longitudinally extending gaps.

7. The wheel weight according to claim 1, wherein the lateral dimensions of the shoulder and the upper bore surface are the same.

8. A vehicle spoke wheel weight comprising:
a body comprising first and second body parts;
each body part comprising a central bore having an upper bore surface, a lower bore surface and a shoulder connecting the upper and lower bore surfaces;
the upper and lower bore surfaces and the shoulder of the central bore of each body part define generally semi-cylindrical surfaces of less than a full semicircle;
the upper and lower bore surfaces and the shoulder having lateral dimensions, the lateral dimension of the lower bore surface being larger than the lateral dimension of the shoulder, the lateral dimensions of the shoulder and the upper bore surface being the same;
a threaded fastener assembly;
the first and second body parts being placeable in a mounting orientation with the central bores of each opposite one another, the first and second body parts being securable to one another by the fastener assembly when in the mounting orientation;
wherein when the first and second body parts are in the mounting orientation:
the first and second body parts define first and second longitudinally extending gaps therebetween; and
the fastener assembly comprises a threaded fastener element extendable between the first and second body parts and through each of the longitudinally extending gaps; and
a shim material placeable at the upper bore surfaces.

9. A spoked wheel assembly comprising:
a circular wheel rim;
a spoke/nipple assembly comprising a spoke nipple mounted to the wheel rim, the spoke nipple having an outer end from which a spoke extends radially inwardly, the outer end having a lateral dimension; and
a vehicle spoke wheel weight comprising:
a body comprising first and second body parts;
each body part comprising a central bore having an upper bore surface, a lower bore surface and a shoulder connecting the upper and lower bore surfaces;
the upper and lower bore surfaces and the shoulder having lateral dimensions, the lateral dimension of the lower bore surface being larger than the lateral dimension of the shoulder;
the lateral dimension of the shoulder being smaller than the lateral dimension of the outer end of the nipple;
the first and second body parts being placeable in a mounting orientation with the central bores of each located opposite one another with:
the upper bore surfaces opposite the spoke;
the lower bore surfaces opposite the nipple;
the shoulders contacting the outer end of the spoke nipple; and
the body being spaced apart from the wheel rim; and
a fastener assembly securing the first and second body parts to one another when in the mounting orientation thereby biasing the lower bore surface against the nipple to secure the vehicle spoke wheel weight to the spoke/nipple assembly.

10. The spoked wheel assembly according to claim 9, wherein:
the upper and lower bore surfaces and the shoulder of the central bore of each body part define generally semi-cylindrical surfaces of less than a full semicircle;
the fastener assembly comprises a threaded fastener assembly;
when the first and second body parts are in the mounting orientation:
the first and second body parts define first and second longitudinally extending gaps therebetween; and
the fastener assembly comprises threaded fastener elements extending between the first and second body parts and through the first and second longitudinally extending gaps.

11. The spoked wheel assembly according to claim 9, further comprising a shim material placeable at the upper bore surfaces.

12. A method for making a vehicle spoke wheel weight of the type for use with a spoke/nipple assembly comprising a spoke nipple mounted to a circular wheel rim, the spoke nipple having an outer end from which a spoke extends radially inwardly, the method comprising:
forming a body comprising first and second body parts with each body part having a face surface;
the body forming step comprising creating a central bore in each body part extending from the face surface, the central bore having an upper bore surface, a lower bore surface and a shoulder connecting the upper and lower bore surfaces, the lower bore surface having a larger lateral dimension than the lateral dimension of the shoulder;
the body forming step comprising forming the central bore so that the central bore of each body part defines a surface of less than a full semi-circle;
creating a fastener assembly for securing the first and second body parts to one another when the first and second body parts are placed in a mounting orientation with the face surfaces and the central bores of each opposite one another; and
configuring the first and second body parts so that the lower bore surface can securely engage a range of sizes of spoke nipples when secured thereto by the fastener assembly.

13. The method according to claim 12, further comprising:
configuring the shoulder to be placeable against an outer end of a spoke nipple, the spoke nipple having a height; and
limiting the height of the lower bore surface to be less than the height of the spoke nipple so that the body is spaced apart from the wheel rim.

14. The method according to claim 12, wherein:
the first and second body parts define a longitudinally extending gap between the face surfaces when in the mounting orientation; and
the first and second body parts configuring step comprises sizing of the gap and sizing of the lateral dimensions of the lower bore surfaces so that the lower bore surfaces of the first and second body parts can be biased against the spoke nipple by the fastener assembly over said range of sizes of spoke nipples.
